(19) United States
(12) Patent Application Publication
(10) Pub. No.: US 2026/0169727 A1
(43) Pub. Date: Jun. 18, 2026

(54) IMAGE FORMING APPARATUS, FIRMWARE UPDATE METHOD, AND FIRMWARE UPDATE SYSTEM

(71) Applicant: KYOCERA DOCUMENT SOLUTIONS INC., Osaka (JP)

(72) Inventor: MIO WAKATSUKI, Osaka (JP)

(21) Appl. No.: 19/417,351

(22) Filed: Dec. 12, 2025

(30) Foreign Application Priority Data
Dec. 16, 2024 (JP) 2024-220120

(51) Int. Cl. G06F 8/65

(52) U.S. Cl. CPC G06F 8/65

(57) ABSTRACT

An image forming apparatus includes a driver controller and an update performing section. The driver controller generates a communication controller when the driver controller determines that a USB driver has received a firmware update request, where the communication controller is a socket that serves as a communication path of communication between the driver controller and the update performing section. The driver controller transmits the firmware update request to the update performing section through the communication controller, and stores firmware for update in a data holding section. The update performing section receives the firmware update request from the driver controller through the communication controller, receives the firmware for update stored in the data holding section from the driver controller through the communication controller, and performs update using the firmware for update according to the firmware update request.

### CROSS-REFERENCE TO RELATED PATENT APPLICATION

This application claims the benefit of Japanese Priority Patent Application JP 2024-220120 filed Dec. 16, 2024, the entire contents of which are incorporated herein by reference.

### FIELD OF THE DISCLOSURE

The present disclosure relates to an image forming apparatus, a firmware update method for updating firmware of the image forming apparatus, and a firmware update system that updates the firmware.

### BACKGROUND OF THE DISCLOSURE

A firmware update for image forming apparatuses such as multifunction peripherals is a function indispensable for, for example, correcting failure, adding new functions, and enhancing the performance. In an existing firmware update, firmware is transmitted from an information processing apparatus such as a PC to an image forming apparatus through a network communication, and update is performed using the firmware.

### SUMMARY OF THE DISCLOSURE

An image forming apparatus according to an embodiment of the present disclosure includes a USB driver, a data holding section, a driver controller, a communication controller, and an update performing section. The USB driver receives a firmware update request including firmware for update from an information processing apparatus through a USB cable connected to a USB port, where the information processing apparatus includes an update tool used to perform an update of firmware of the image forming apparatus. The driver controller generates the communication controller when the driver controller determines that the USB driver has received the firmware update request, where the communication controller is a socket that serves as a communication path of communication between the driver controller and the update performing section. The driver controller transmits the firmware update request to the update performing section through the communication controller, and stores the firmware for update in the data holding section. The update performing section receives the firmware update request from the driver controller through the communication controller, receives the firmware for update stored in the data holding section from the driver controller through the communication controller, and performs update using the firmware for update according to the firmware update request.

A firmware update method according to an embodiment of the present disclosure includes receiving, by a USB driver of an image forming apparatus, a firmware update request including firmware for update from an information processing apparatus through a USB cable connected to a USB port, where the information processing apparatus includes an update tool used to perform an update of firmware of the image forming apparatus. A communication controller is generated by a driver controller of the image forming apparatus when the driver controller determines that the USB driver has received the firmware update request, where the communication controller is a socket that serves as a communication path of communication between the driver controller and an update performing section. The firmware update request is transmitted by the driver controller to the update performing section through the communication controller. The firmware for update is stored by the driver controller in a data holding section. The firmware update request is received by the update performing section of the image forming apparatus from the driver controller through the communication controller. The firmware for update stored in the data holding section is received by the update performing section from the driver controller through the communication controller. Update is performed by the update performing section using the firmware for update according to the firmware update request.

A firmware update system according to an embodiment of the present disclosure includes an image forming apparatus and an information processing apparatus. The information processing apparatus includes an update tool used to perform an update of firmware of the image forming apparatus through a USB cable connected to a USB port. The image forming apparatus includes a USB driver, a data holding section, a driver controller, a communication controller, and an update performing section. The USB driver receives a firmware update request including firmware for update from the information processing apparatus. The driver controller generates the communication controller when the driver controller determines that the USB driver has received the firmware update request, where the communication controller is a socket that serves as a communication path of communication between the driver controller and the update performing section. The driver controller transmits the firmware update request to the update performing section through the communication controller, and stores the firmware for update in the data holding section. The update performing section receives the firmware update request from the driver controller through the communication controller, receives the firmware for update stored in the data holding section from the driver controller through the communication controller, and performs update using the firmware for update according to the firmware update request.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 illustrates a configuration of a firmware update system according to an embodiment of the present disclosure.

FIG. 2 illustrates a hardware configuration of an image forming apparatus.

FIG. 3 illustrates a hardware configuration of an information processing apparatus.

FIG. 4 illustrates an architecture of the image forming apparatus.

FIG. 5 illustrates a flow of an operation of the firmware update system.

FIG. 6 illustrates a GUI of an update tool.

### DETAILED DESCRIPTION OF THE EXEMPLARY EMBODIMENTS

Typically, there is a need for a network communication system and an optional address for communication in order to update firmware of an image forming apparatus. However, depending on how to manage an image forming apparatus, network connection is not established in some cases for, for example, security measures. Further, in some cases, an information processing apparatus is connected to a VPN for reason of working from home or remote working these days, and thus the information processing apparatus is not in the same network as an image forming apparatus. In such a case, a firmware update is not performed through network communication. The firmware update is a function indispensable for, for example, correcting failure, adding new functions, and enhancing the performance. Thus, a faulty image forming apparatus may be used if the firmware update is not performed.

In view of the circumstances described above, it is an object of the present technology to perform a firmware update without network communication.

Hereinafter, an embodiment of the present disclosure will be described with reference to the drawings.

### 1. Configuration of Firmware Update System

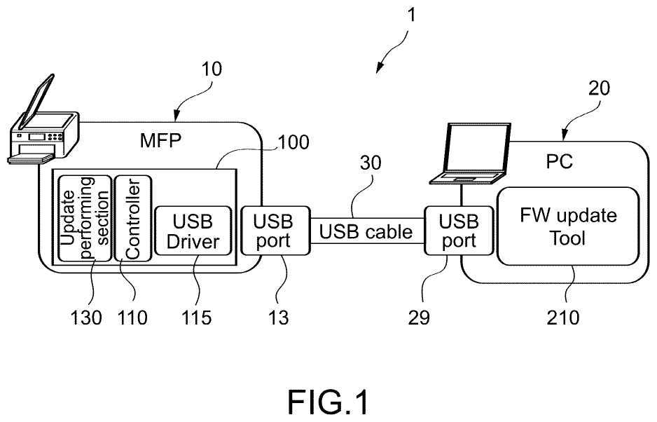

FIG. 1 illustrates a configuration of a firmware update system according to an embodiment of the present disclosure.

A firmware update system 1 includes an image forming apparatus 10 and an information processing apparatus 20. The image forming apparatus 10 and the information processing apparatus 20 are connected to each other through a USB cable 30.

The image forming apparatus 10 is, for example, a multifunction peripheral. Firmware of the image forming apparatus 10 is updated for, for example, correcting failure, adding new functions, and enhancing the performance.

The information processing apparatus 20 is, for example, a personal computer. The information processing apparatus 20 includes an update tool 210 used to perform an update of the firmware of the image forming apparatus 10.

### 2. Hardware Configuration of Image Forming Apparatus

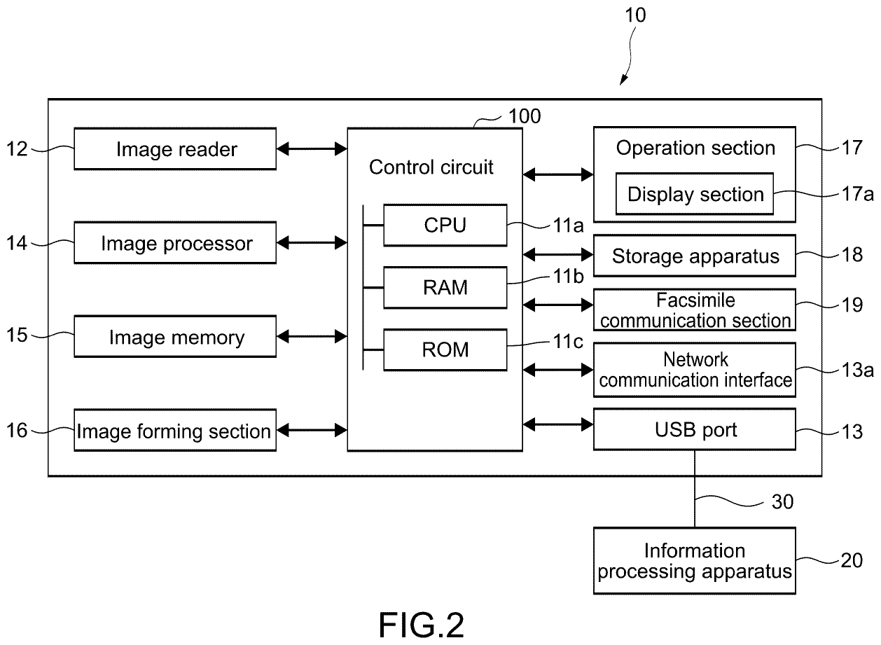

FIG. 2 illustrates a hardware configuration of the image forming apparatus.

The image forming apparatus 10 includes a control circuit 100 that is included in a computer. The control circuit 100 includes, for example, a central processing unit (CPU) 11a that is a processor, a random access memory (RAM) 11b, a read only memory (ROM) 11c that is a memory, and a dedicated hardware circuit, and controls an overall operation of the image forming apparatus 10. The CPU 11a loads an information processing program stored in the ROM 11c into the RAM 11b and executes the program to perform an operation described using an operation flow described below, and controls display and operation input that are performed on a touchscreen 17. The ROM 11c permanently stores therein, for example, a program executed by the CPU 11a and data. The ROM 11c is an example of a non-transitory computer-readable recording medium.

The control circuit 100 is connected to, for example, an image reader 12 (an image scanner), an image processor 14 (including a graphics processing unit (GPU)), an image memory 15, an image forming section 16 (a printer), the touchscreen (a front panel) 17 that is an operation section including a display section 17a, a large-capacity nonvolatile storage apparatus 18 such as a hard disk drive (HDD) or a solid state drive (SSD), a facsimile communication section 19, a network communication interface 13a (not used in the present embodiment), and a USB port 13 to which the USB cable 30 is connected. The control circuit 100 controls operations of the connected components described above, and performs transmission of a signal or data to and reception of a signal or data from each of the connected components. The operation section corresponding to the touchscreen 17 is an embodiment of an input apparatus, and a sound input apparatus that includes a microphone may be provided as the input apparatus.

### 3. Hardware Configuration of Information Processing Apparatus

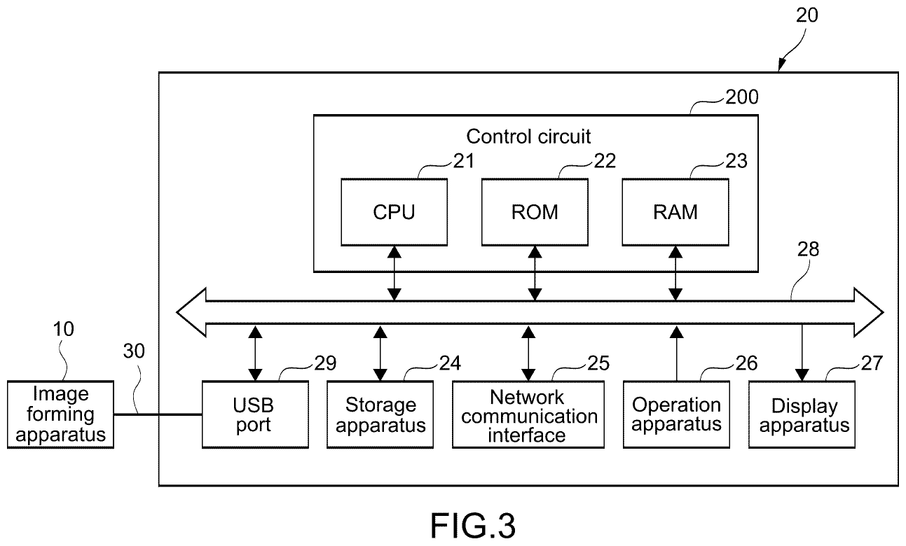

FIG. 3 illustrates a hardware configuration of the information processing apparatus.

The information processing apparatus 20 includes a CPU 21 (a processor), a ROM 22, a RAM 23, a large-capacity nonvolatile storage apparatus 24 such as a HDD or an SSD, a network communication interface 25 (not used in the present embodiment), a USB port 29 to which the USB cable 30 is connected, an operation apparatus 26 (such as a keyboard, a mouse, a touchscreen, and a hardware switch), a display apparatus 27 (a display), and a bus 28 through which these components are connected to each other.

The CPU 21, the ROM 22, and the RAM 23 are included in a control circuit 200. The CPU 21 loads an information processing program stored in the ROM 22 into the RAM 23 and executes the program. The ROM 22 permanently stores therein, for example, a program executed by the CPU 21 and data. The ROM 22 is an example of a non-transitory computer-readable recording medium. The ROM 22 stores therein the update tool 210 (FIG. 1).

### 4. Architecture of Image Forming Apparatus

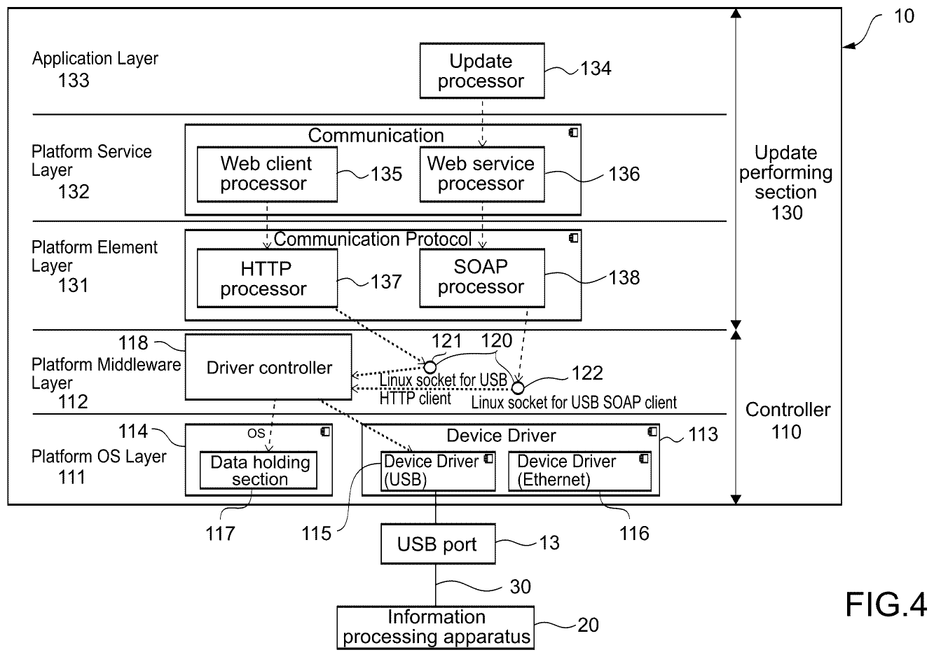

FIG. 4 illustrates an architecture of the image forming apparatus.

The image forming apparatus 10 includes a controller 110 and an update performing section 130. The controller 110 includes an OS layer 111 and a middleware layer 112. The update performing section 130 includes an element layer 131, a service layer 132, and an application layer 133, and performs a firmware update. Specifically, the application layer 133 includes an update processor 134. The update processor 134 performs various detailed update-related processes upon performing an actual update. The service layer 132 includes a Web client processor 135 and a Web service processor 136. The Web client processor 135 performs a process on Web-client-related control. The Web service processor 136 performs a process on Web-service-related control. The element layer 131 includes an HTTP processor 137 and a SOAP processor 138.

The OS layer 111 includes a device driver 113 and an OS 114. The device driver 113 includes a USB driver 115 and an Ethernet driver 116 (not used in the present embodiment). The USB driver 115 controls the USB port 13 such that the image forming apparatus 10 transmits information to and receives information from the information processing apparatus 20 through the USB cable 30 connected to the USB port 13. The USB driver 115 serves as an intermediary for intaking information transmitted by the information processing apparatus 20 through the USB cable 30. The OS 114 includes a data holding section 117. The data holding section 117 is a storage region that stores therein transmitted and received firmware and communication data.

The middleware layer 112 includes a driver controller 118. When the driver controller 118 receives a firmware update request from the USB driver 115, the driver controller 118 transmits, to the update performing section 130 performing a firmware update, the firmware update request. Note that the image forming apparatus 10 supports a plurality of functions. Thus, the driver controller 118 performs control such that requests about respective functions are respectively transmitted to function performing sections that perform the respective functions. The driver controller 118 determines each function using a USB alternative function. When the driver controller 118 receives data via a port used for firmware update, the driver controller 118 determines that the USB driver 115 has received the firmware update request. Using, as a firmware update trigger, information received via the port used for firmware update, the driver controller 118 generates a communication controller 120 in order to perform a firmware update.

The communication controller 120 is a socket (typically a Linux socket) that serves as a communication path of communication between the driver controller 118 and the update performing section 130. The communication controller 120 transmits data to the update performing section 130, and receives data from the update performing section 130. The communication controller 120 includes a USB HTTP client 121 and a USB SOAP client 122.

### 5. Operation of Firmware Update System

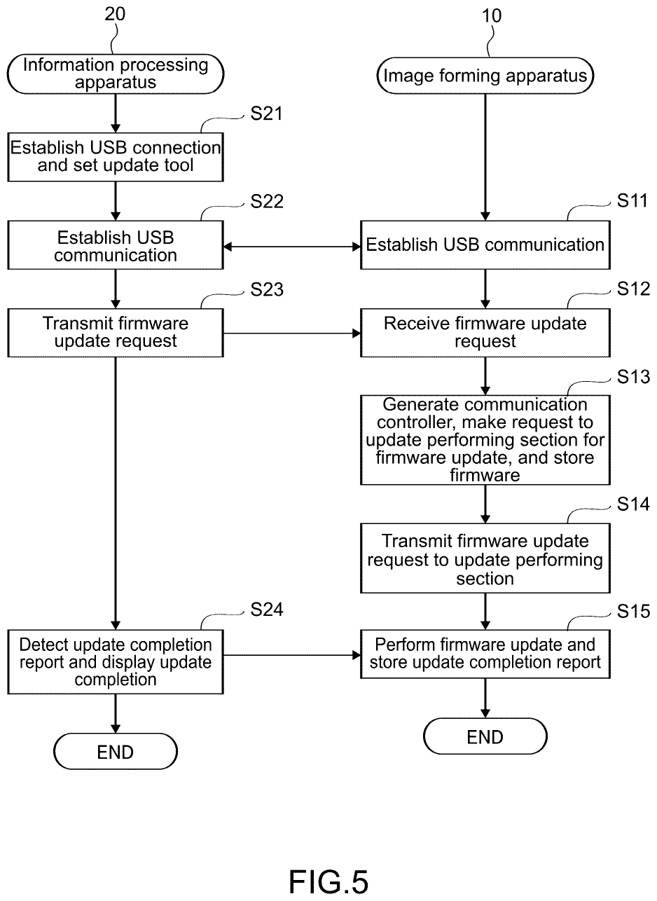

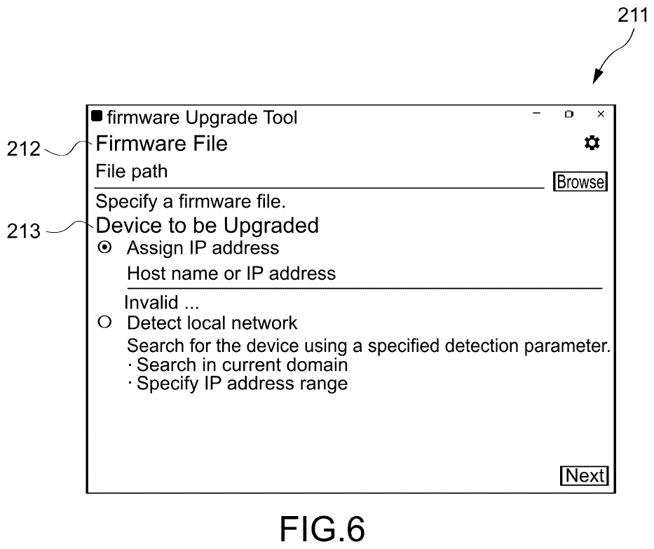

FIG. 5 illustrates a flow of an operation of the firmware update system. FIG. 6 illustrates a GUI of an update tool.

The image forming apparatus 10 and the information processing apparatus 20 are connected to each other through the USB cable 30. The control circuit 200 of the information processing apparatus 20 activates the update tool 210. The update tool 210 displays a GUI 211 on the display apparatus 27. A user operates the operation apparatus 26 to set a firmware file 212. The firmware file 212 is a file of firmware for update for the image forming apparatus 10. The user operates the operation apparatus 26 to set a device 213 of which firmware is to be updated (the image forming apparatus 10) (Step S21).

When the firmware file 212 and the device 213 to be updated (the image forming apparatus 10) are set in a state in which the image forming apparatus 10 and the information processing apparatus 20 are connected to each other through the USB cable 30, the update tool 210 starts performing update. Specifically, the update tool 210 creates an HTTPS communication path over the USB cable 30 as a communication path of communication with the image forming apparatus 10. The update tool 210 performs transport-layer-security (TLS) handshake that is control performed to communicate with the USB driver 115 of the image forming apparatus 10 using HTTPS (Step S22, Step S11).

The update tool 210 transmits a firmware update request to the image forming apparatus 10 through the USB cable 30 using HTTPS communication. The firmware update request includes firmware for update (Step S23).

The USB driver 115 of the image forming apparatus 10 receives the firmware update request from the update tool 210 of the information processing apparatus 20 through the USB cable 30 using HTTPS communication (Step S12). The USB driver 115 transmits the firmware update request to the driver controller 118. The image forming apparatus 10 enters a firmware update mode in response to a firmware update being triggered by the update tool 210, and starts performing the firmware update.

The driver controller 118 determines that data received from the USB driver 115 is the firmware update request. In other words, the driver controller 118 receives the firmware update request from the USB driver 115. Specifically, when the driver controller 118 receives data via the port used for firmware update, the driver controller 118 determines that the USB driver 115 has received the firmware update request. Using, as a firmware update trigger, information received via the port used for firmware update, the driver controller 118 generates the communication controller 120 in order to perform the firmware update. The communication controller 120 is a socket that serves as a communication path of communication between the driver controller 118 and the update performing section 130. The driver controller 118 transmits the firmware update request to the update performing section 130 through the communication controller 120, and stores the firmware for update in the data holding section 117 (Step S13).

The communication controller 120 receives the firmware update request from the driver controller 118, and transmits the firmware update request to the update performing section 130 (Step S14).

The update performing section 130 receives the firmware update request from the driver controller 118 through the communication controller 120. The update performing section 130 receives the firmware for update stored in the data holding section 117 from the driver controller 118 through the communication controller 120. The update performing section 130 performs update using the firmware for update according to the firmware update request. When the update is completed, the update performing section 130 causes the driver controller 118 through the communication controller 120 to store an update completion report in the data holding section 117 (Step S15).

The update tool 210 of the information processing apparatus 20 monitors the data holding section 117, and when the update tool 210 detects the update completion report stored in the data holding section 117, the update tool 210 displays update completion on the display apparatus 27 (Step S24).

### 6. Conclusion

Depending on how to manage an image forming apparatus, network connection is not established in some cases for, for example, security measures. Further, in some cases, an information processing apparatus is connected to a VPN for reason of working from home or remote working these days, and thus the information processing apparatus is not in the same network as an image forming apparatus. In such a case, a firmware update is not performed through network communication. The firmware update is a function indispensable for, for example, correcting failure, adding new functions, and enhancing the performance. Thus, a faulty image forming apparatus may be used if the firmware update is not performed.

On the other hand, the present embodiment enables firmware update using a USB cable, and this enables a user in an environment described above to use an image forming apparatus with up-to-date firmware. The use of the present embodiment enables an information processing apparatus to directly perform a firmware update. This enables people in a greater number of cases to perform a firmware update. As a result, the user can use an image forming apparatus with up-to-date firmware.

Although each embodiment and each modified example of the present technology have been described above, the present technology is not limited to the above-mentioned embodiments, and various modifications can be made without departing from the gist of the present technology as a matter of course.

What is claimed is:

1. An image forming apparatus, comprising:
a USB driver that receives a firmware update request including firmware for update from an information processing apparatus through a USB cable connected to a USB port, the information processing apparatus including an update tool used to perform an update of firmware of the image forming apparatus;
a data holding section;
a driver controller
that generates a communication controller when the driver controller determines that the USB driver has received the firmware update request, the communication controller being a socket that serves as a communication path of communication between the driver controller and an update performing section,
that transmits the firmware update request to the update performing section through the communication controller, and
that stores the firmware for update in the data holding section;
the communication controller generated by the driver controller; and
the update performing section
receiving the firmware update request from the driver controller through the communication controller,
receiving the firmware for update stored in the data holding section from the driver controller through the communication controller, and
performing update using the firmware for update according to the firmware update request.

2. The image forming apparatus according to claim 1, wherein
when the driver controller receives data via a port used for firmware update, the driver controller determines that the USB driver has received the firmware update request.

3. The image forming apparatus according to claim 1, wherein
the USB driver and the data holding section are included in an OS layer,
the driver controller and the communication controller are included in a middleware layer, and
the update performing section includes an application layer.

4. The image forming apparatus according to claim 1, wherein
the update tool of the information processing apparatus creates an HTTPS communication path over the USB cable as a communication path of communication with the image forming apparatus.

5. A firmware update method, comprising:
receiving, by a USB driver of an image forming apparatus, a firmware update request including firmware for update from an information processing apparatus through a USB cable connected to a USB port, the information processing apparatus including an update tool used to perform an update of firmware of the image forming apparatus;
generating, by a driver controller of the image forming apparatus, a communication controller when the driver controller determines that the USB driver has received the firmware update request, the communication controller being a socket that serves as a communication path of communication between the driver controller and an update performing section;
transmitting, by the driver controller, the firmware update request to the update performing section through the communication controller;
storing, by the driver controller, the firmware for update in a data holding section;
receiving, by the update performing section of the image forming apparatus, the firmware update request from the driver controller through the communication controller;
receiving, by the update performing section, the firmware for update stored in the data holding section from the driver controller through the communication controller; and
performing, by the update performing section, update using the firmware for update according to the firmware update request.

6. A firmware update system, comprising:
an image forming apparatus; and
an information processing apparatus that includes an update tool used to perform an update of firmware of the image forming apparatus through a USB cable connected to a USB port,
the image forming apparatus including
a USB driver that receives a firmware update request including firmware for update from the information processing apparatus,
a data holding section,
a driver controller
that generates a communication controller when the driver controller determines that the USB driver has received the firmware update request, the communication controller being a socket that serves as a communication path of communication between the driver controller and an update performing section,
that transmits the firmware update request to the update performing section through the communication controller, and
that stores the firmware for update in the data holding section,
the communication controller generated by the driver controller, and
the update performing section
receiving the firmware update request from the driver controller through the communication controller,
receiving the firmware for update stored in the data holding section from the driver controller through the communication controller, and
performing update using the firmware for update according to the firmware update request.
